(19) United States
(12) Patent Application Publication
(10) Pub. No.: US 2005/0248659 A1
(43) Pub. Date: Nov. 10, 2005

(54) Exposure apparatus, and method, device manufacturing method, pattern generator and maintenance method

(76) Inventors: Kazuyuki Kasumi, Utsunomiya-shi (JP); Hirohisa Ota, Kawagoe-shi (JP); Eigo Kawakami, Utsunomiya-shi (JP); Takashi Nakamura, Tokyo (JP); Toshinobu Tokita, Yokohama-shi (JP)

Correspondence Address: MORGAN & FINNEGAN, L.L.P., 3 WORLD FINANCIAL CENTER, NEW YORK, NY, 10281-2101, US

(21) Appl. No.: 11/112,901

(22) Filed: Apr. 22, 2005

(30) Foreign Application Priority Data
Apr. 23, 2004 (JP) 2004-127620 (PAT.

(51) Int. Cl. H04N 5/225

(52) U.S. Cl. 348/207.99

(57) ABSTRACT

An exposure apparatus includes a projection optical system for projecting a predetermined pattern onto an object to be exposed, and a pattern generating unit that includes plural pixels, and generates the predetermined pattern by driving the plural pixels, wherein the pattern generating unit has an alignment mark used for an alignment between the predetermined pattern and the object, on approximately the same surface as a surface on which the predetermined pattern is formed.

### BACKGROUND OF THE INVENTION

The present invention relates generally to an exposure apparatus and method, and more particularly to an exposure apparatus and method used to manufacture various devices including semiconductor chips such as ICs and LSIs, a display device such as a liquid crystal panel, a sensing device such as a magnetic head, an image pick-up device such as a CCD, and a fine pattern for micromechanics. The present invention is suitable, for example, for a maskless exposure apparatus that utilizes a spatial modulation element (pattern generating means), such as a micro-mirror array, and a projection type image display unit (pattern generator), such as a projector that displays an image on a screen.

Due to the demand by the large personal computer (“PC”) market, the fine processing of the semiconductor integrated circuits (“ICs”) has rapidly developed, and the design rule of 90 nm has been achieved. Many devices are produced as highly versatile and marketable microprocessor units (“MPUs”) and memories for use with the PCs. These MPUs and the memories use the same devices even for different PC manufacturers and models, and the same semiconductor devices are manufactured in huge quantities.

The information appliances are expected to be the largest market in the future for the semiconductor devices along with the widespread digital TVs, versatile cellular phones, networks, etc. The information appliances use unique semiconductor devices (or system LSIs) suitable for their manufacturers and models, and require the manufacture of various types of devices. The information appliances are designed and produced based on consumers' demands. Various consumers' demands require the manufacture of various products, and limit the number of units produced per model. Individual demands are so fluid that the products need to be put onto the market at the proper times based on the consumers' demands.

For the conventional semiconductor devices typified by the MPUs and memories, the same model can be produced in large quantities over a long time period of time. On the other hand, for the semiconductor devices (or system LSIs) in the information appliances, various types should be produced in small quantities only for short periods or time and placed in the market at the proper times.

A projection exposure apparatus, which has conventionally been used, projects a circuit pattern of a mask (or a reticle) onto a wafer etc. via a projection optical system and transfers the circuit pattern in a lithography that serves as the important technology for production of the semiconductor devices. For the fine processing and the high integration of the semiconductor devices, the projection exposure apparatus can now transfer a pattern smaller than the exposure wavelength by using, for example, a phase shift mask, etc. The phase shift mask is more complicated and thus more expensive than a conventional binary mask.

If the duplicate device is produced in large quantities, the mask cost per device is reduced. However, when the number of produced system LSIs are low, a mask cost increases, which makes the device and mask expensive, such as the phase shift mask. The information appliances are subject to keen price competition similar to conventional home electric appliances, and preferably avoid use of expensive semiconductor devices.

Accordingly, use of a direct imaging type of exposure apparatus (referred to as a “maskless exposure apparatus” hereinafter) to produce the system LSIs attracts attention. The maskless exposure apparatus uses no mask, and can start producing the devices without producing a mask once a device circuit design is determined. The maskless exposure apparatus eliminates the mask cost, and reduces the device producing time period.

While one illustrative maskless exposure apparatus is an electron beam exposure apparatus, its throughput is too low for the actual device manufacturing. Currently, the electron beam exposure apparatus is used for such limited applications as the reticle patterning and the advanced device research and development. Accordingly, there is proposed an electron beam exposure apparatus that exposes the preinstalled pattern entirely for the improved throughput.

There is proposed a maskless exposure apparatus that uses a similar light source to that of a conventional exposure apparatus. See, for example, U.S. Pat. No. 5,330,878. This maskless exposure apparatus includes a spatial modulation element that has plural micro-mirrors, and arranges the spatial modulation element at a position corresponding to a mask position in a conventional exposure apparatus. The maskless exposure apparatus generates a circuit pattern by controlling driving of thousands of about 10 μm square micro-mirrors (or by controlling each micro-mirror's inclination and the resultant light reflections), projects and transfers a reduced size of the circuit pattern. The electron beam exposure apparatus requires a wafer to be housed in the vacuum atmosphere, whereas the exposure apparatus that uses the spatial modulation element permits exposures in the air and thus advantageously requires no vacuuming apparatus.

A production of the system LSI needs to overlay plural layers of circuit patterns on a wafer, thus requiring high alignment or overlay accuracy between a fine pattern and an undercoat layer. Accordingly, there are proposed various exposure methods that use a condensed spot beam and correct imaging positions along the undercoat distortion for high overlay accuracy. One illustrative method obtains the distortion data (including the distortion of the optical system in the exposure apparatus used for undercoat transferring and the distortion that occurs in the post-exposure process) from distortion measuring marks latticed in a circuit pattern on an undercoat wafer, and corrects exposure positions of the electron beam based on the distortion data. See, for example, Japanese Patent Application, Publication No. 62-58621.

However, no alignment or overlay methods between the undercoat wafer and the pattern to be imaged have been proposed for an exposure apparatus that uses the spatial modulation element.

The conventional alignment method requires distortion measuring marks to be arranged in each chip pattern of the undercoat wafer, which are unnecessary for the original device functions, disadvantageously restricting the device design.

### BRIEF SUMMARY OF THE INVENTION

The present invention is directed to an exposure apparatus and method, which does not restrict the device design, and provides high overlay accuracy.

An exposure apparatus according to one aspect of the present invention includes a projection optical system for projecting a predetermined pattern onto an object to be exposed, and a pattern generating unit that includes plural pixels, and generates the predetermined pattern by driving the plural pixels, wherein the pattern generating unit has an alignment mark used for an alignment between the predetermined pattern and the object, on approximately the same surface as a surface on which the predetermined pattern is formed.

An exposure apparatus according to another aspect of the present invention includes a projection optical system for projecting a predetermined pattern onto an object to be exposed, and a pattern generating unit that includes plural pixels, and generates the predetermined pattern by driving the plural pixels, wherein a first alignment mark used for an alignment between the predetermined pattern and the object is arranged on a side of the pattern generating unit on approximately the same surface as a surface on which the predetermined pattern is formed, and wherein a second alignment mark used for an alignment between the predetermined pattern and the object is arranged on a side of the object on approximately the same surface as a focal plane of the projection optical system.

An exposure method according to another aspect of the present invention for exposing an object so that a first pattern that is generated by driving plural pixels matches a second pattern that is formed on the object includes the steps of storing as correction data an offset amount of the second pattern from an ideal position, and forming the first pattern based on the correction data.

An exposure apparatus that has an exposure mode for executing the above exposure method, and A device manufacturing method that includes the steps of exposing an object using the above exposure apparatus, and developing the object that has been exposed constitute another aspect of the present invention.

A pattern generator according to another aspect of the present invention includes plural pixels, the pattern generator generating the predetermined pattern by driving the plural pixels, wherein the pattern generator has a reference mark for the predetermined pattern, on approximately the same surface as a surface on which the predetermined pattern is formed.

An alignment method according to another aspect of the present invention includes between a predetermined pattern and an object used for an exposure apparatus that includes a projection optical system for projecting a predetermined pattern onto an object to be exposed, and a pattern generating unit that includes plural pixels, and generates the predetermined pattern by driving the plural pixels includes a first obtaining step for obtaining a position of a stage that supports the object, when a reference mark arranged on the stage on approximately the same surface as an exposed surface of the object matches an alignment mark arranged on approximately the same surface as a surface on which a pattern is generated by the pattern generating unit, a second obtaining step of obtaining a position of the stage, when a position of the reference mark matches a position of a measurement reference position for a measuring unit that measures a position of the object, a calculating step for calculating an offset based on results of the first and second obtaining steps, and an alignment step for providing an alignment between the predetermined pattern and the object based on the offset and a measuring result by the measuring unit.

Other objects and further features of the present invention will become readily apparent from the following description of the preferred embodiments with reference to the accompanying drawings.

### BRIEF DESCRIPTION OF THE DRAWINGS

FIG. 1 is a schematic sectional view of a structure of an exposure apparatus according to one aspect of the present invention.

FIG. 2 is a plane view of a micro-mirror array shown in FIG. 1 on a reflection surface side.

FIG. 3 is a schematic sectional view showing a baseline correction by the exposure apparatus shown in FIG. 1.

FIG. 4 is a plane view of the micro-mirror array shown in FIG. 1 on a reflection surface side.

FIG. 5 is a schematic sectional view of a structure of an exposure apparatus according to one aspect of the present invention.

FIGS. 6A and 6B are plane and sectional views of the micro-mirror array shown in FIG. 5.

FIG. 7 is a plane view showing a wafer that has a distortion measuring mark shot to be exposed at part of its layout.

FIG. 8 is a view that illustrates a design coordinate and a corrective coordinate for a wafer.

FIGS. 9A to 9C are views showing a wafer that has experienced an undercoat exposure by a conventional exposure apparatus, and then receives an upper layer patterned by the inventive exposure apparatus.

FIG. 10 is a plane view showing a specific chip on the wafer.

FIG. 11 is a flowchart for explaining a method for fabricating devices (semiconductor chips such as ICs, LSIs, and the like, LCDs, CCDs, etc.).

FIG. 12 is a detailed flowchart for Step 3 of wafer process shown in FIG. 11.

### DETAILED DESCRIPTION OF THE PREFERRED EMBODIMENTS

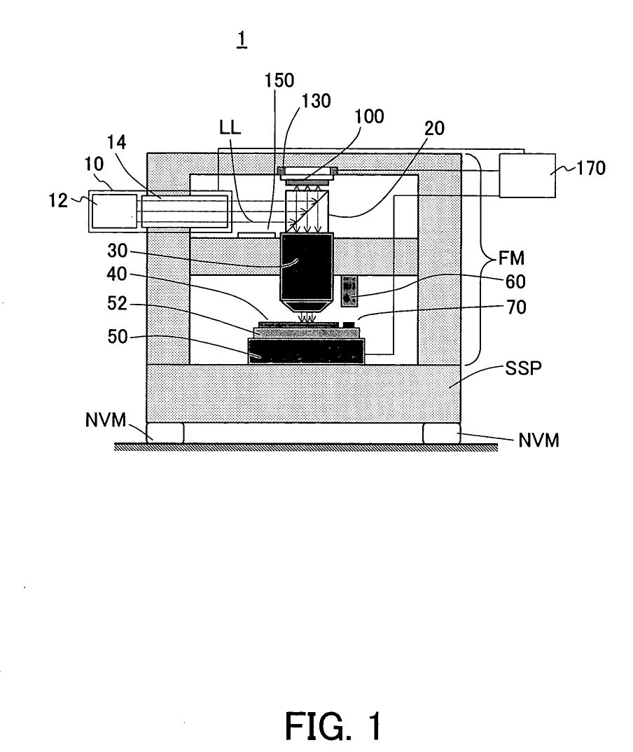

With reference to the accompanying drawings, a description will be given of an exposure apparatus 1 according to one aspect of the present invention. Like elements in each figure are designated by the same reference numerals, and a duplicate description will be omitted. FIG. 1 is a schematic sectional view of a structure of the inventive exposure apparatus 1.

The exposure apparatus 1 is a maskless type projection exposure apparatus that exposes a circuit patter generated by a micro-mirror array as a pattern generating means (or a spatial modulation element), onto a wafer. The exposure apparatus 1 arranges a micro-mirror array at a position corresponding to a mask position in an exposure apparatus that uses the mask, and forms a circuit pattern by selecting reflection or shielding by controlling an inclination or the mirror. Such an exposure apparatus is suitable for a sub-micron or quarter-micron lithography process, for example, for the system LSIs.

The exposure apparatus 1 includes, as shown in FIG. 1, an illumination apparatus 10, a beam splitter 20, a projection optical system 30, a wafer stage 50 mounted with a wafer 40, an off-axis scope (as a measuring means) 60, a micro-mirror array 100, a mirror driving mechanism 130, an alignment scope (as a detecting means) 150, and a controller 170.

The exposure apparatus 1 further includes a stage stool SSP that supports the whole apparatus, a frame FM, and a vibration isolator NVM. The stage stool SSP serves as a reference surface for movements of the wafer stage 50, which will be described later. The frame FM supports an optical system etc. provided on the stage stool SSP. The vibration isolator NVM absorbs vibrations from the floor surface under the stage stool SSP.

The illumination apparatus 10 illuminates the micro-mirror array 100 that generates a circuit pattern to be transferred, and includes a light source section 12 and an illumination optical system 14.

The light source section 12 uses, for example, a light source such as an ArF excimer laser with a wavelength of approximately 193 nm and a KrF excimer laser with a wavelength of approximately 248 nm. However, the laser type is not limited to excimer lasers and, for example, an F₂ laser with a wavelength of approximately 157 nm and an extreme ultraviolet (“EUV”) light having a wavelength of 20 nm or smaller may be used. Similarly, the number of laser units is not limited. For example, spackles caused by the coherence remarkably reduce when two independently operating solid lasers are used. An optical system (not shown) for reducing speckles may swing linearly or rotationally on the optical path. A light source applicable for the light source section 12 is not limited to a laser, and may use one or more lamps such as a mercury lamp and a xenon lamp.

The illumination optical system 14 is an optical system that introduces the illumination light LL emitted from the light source section 12 into the apparatus, and includes a lens, a mirror, an optical integrator, a stop and the like, for example, a condenser lens, a fly-eye lens, an aperture stop, a condenser lens, a slit, and an imaging optical system in this order. The illumination optical system 14 can use any light regardless of whether it is axial or non-axial light. The light integrator may include a fly-eye lens or an integrator formed by stacking two sets of cylindrical lens array plates (or lenticular lenses), and can be replaced with an optical rod or a diffractive optics.

The beam splitter 20 reflects the illumination light LL from the illumination optical system 14 towards the micro-mirror array 100. The beam splitter 20 transmits the light that is reflected by the micro-mirror array 100 and reflects the circuit pattern, toward the projection optical system 30. The micro-mirror array 100, which will be described later, forms an image by selecting to reflect or not reflect the light from each of plural fine mirrors, and returns the exposure light. While this embodiment arranges the beam splitter 20 between the illumination optical system 14 and the micro-mirror array 100, the exposure apparatus may omit the beam splitter 20.

The projection optical system 30 images a circuit pattern generated by the micro-mirror array 100, onto a surface of the wafer 40. The projection optical system 30 may use an optical system comprising solely of a plurality of lens elements, a (catadioptric) optical system including a plurality of lens elements and at least one concave mirror, an optical system including a plurality of lens elements and at least one diffractive optical element such as a kinoform, a full mirror type optical system, and so on. Any necessary correction of the chromatic aberration may be accomplished by using a plurality of lens units made from glass materials having different dispersion values (Abbe values) or arranging a diffraction optics such that it disperses light in a direction opposite to that of the lens unit.

The wafer 40 is an object to be exposed, and photo resist is applied to the wafer 40. The circuit pattern generated by the micro-mirror array 100 is exposed onto the wafer 40. Another embodiment replaces the wafer 40 with a liquid crystal substrate and another object to be exposed.

The wafer stage 50 supports the wafer 40 via a wafer chuck (not shown), and is connected to a moving mechanism (not shown). The moving mechanism (not shown) uses, for example, a linear motor to move the wafer 40 in XYZ-axes directions and rotating directions around each axis. The wafer stage 50 moves the wafer 40 in the Y axis direction for exposure of the entire wafer surface. The wafer stage 50 serves an alignment between a (first) pattern generated by the micro-mirror array and a circuit or undercoat pattern (as a second pattern) on the wafer 40 surface. The moving direction within the wafer 40 surface is the Y axis. A direction perpendicular to the Y axis is the X axis. A direction perpendicular to the wafer 40 surface is the Z axis.

The off-axis scope 60 serves to detect a position of the wafer 40 and includes, for example, a light source, a beam splitter, a lens, and a photoelectric conversion element. The off-axis scope 60 is arranged so that the photoelectric conversion element is approximately conjugate with the wafer 40 or a reflected point of the reflected light from a reference mark 70, which will be described later. The off-axis scope 60 detects a positional offset of the wafer 40 (or the reference mark 70) in the optical-axis direction (or Z-axis direction) of the projection optical system 30, as a positional offset on the photoelectric conversion element.

The reference mark (or second alignment mark) 70 is arranged in a predetermined range near the wafer 40 on the wafer chuck 52 so that it is approximately level with the top surface of the wafer 40 (or the focal plane of the projection optical system 30). The reference mark 70 is made, for example, of metal, such as Cr and Al, as a line and space pattern having a line shaped opening whose size on the wafer side is close to the exposure resolution critical dimension. The reference mark 70 is used for the baseline correction, as described later.

The micro-mirror array 100 serves to generate a circuit pattern to be transferred. More specifically, the micro-mirror array 100 forms a circuit pattern by selecting to reflect or not reflect from each of plural fine mirrors in the micro-mirror array 100. A mirror driving mechanism 130 adjusts an orientation of the micro-mirror array 100. The mirror driving mechanism 130 can change the position and orientation of the micro-mirror array 100, but primarily rotates the micro-mirror array 100 at a fine angle around the optical axis in the normal exposure.

The micro-mirror array arranges many fine plane square mirrors (about 10 μm square) that are formed by the micro electromechanical systems (“MEMS”) technology. The micro-mirror array generally has millions of mirrors, or thousands of mirrors times thousands of mirrors lengthwise and crosswise. If each mirror is as large as 10 μm square, a pattern generating part in the micro-mirror array 100 will become as large as about 20 mm.

A reticle used to manufacture the current advanced semiconductor device is four to five times as large as the device size or about 100 nm square. The device pattern size is merely as large as about 100 nm, and the mask pattern size is smaller than 1 μm. Thus, the conventional exposure apparatus mounted with the micro-mirror array 100 cannot provide a desired pattern size. Accordingly, the projection optical system 30 is adapted to have a reduction ratio of about 100 times, for example. Thereby, the exposure angle of field on the wafer surface is 200 mm×200 μm, when the micro-mirror array 100 is as large as 20 mm×20 mm.

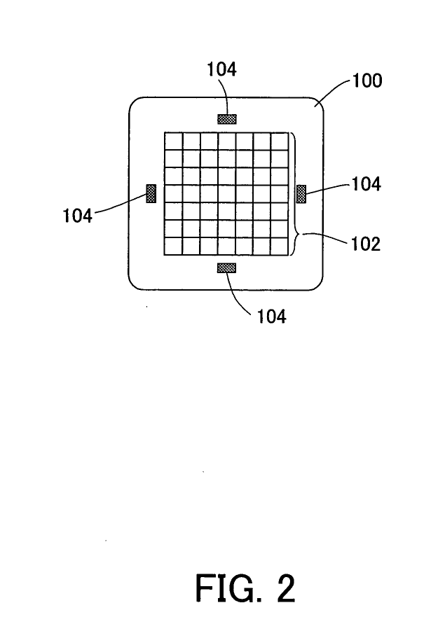

FIG. 2 shows the micro-mirror array 100 of this embodiment. FIG. 2 is a plane view of the micro-mirror array 100 when the micro mirror array 100 is viewed from the reflection surface side of the fine mirrors. Referring to FIG. 2, plural fine mirrors (or mirror array) 102 and four (first) alignment marks 104 are arranged on the (reflection) surface of the micro-mirror array 100. While FIG. 2 shows only a small number of mirrors 102, thousands by thousands fine mirrors are actually arranged, as discussed above. The alignment marks 104 are chrome-patterned, etc. on the same plane as the reflection surface of the mirror array 102. The mirror array 102 is formed by the Si fine processing, and the alignment marks 104 are easily formed on the same plane when the similar processing is used to manufacture the mirror.

The alignment scope 150 detects a surface position of the micro-mirror array 100. The alignment scope 150 includes, for example, substantially the same light source as the exposure light, i.e., a light source that emits substantially the same wavelength as that of the exposure light, a fiber that introduces the light from the light source to an illumination part, the illumination part that illuminates the alignment marks 104 on the micro-mirror array 100, and a sensor that detects the light intensity from the alignment marks 104.

The controller 170 includes a CPU and memory (not shown), and controls operations in the exposure apparatus 1. The controller 170 is electrically connected to the illumination apparatus 10, (the moving mechanism (not shown) in) the wafer stage 50, and the mirror driving mechanism 130. The CPU includes any processor irrespective of its name, such as an MPU, and controls operations of each component. The memory includes a ROM and RAM, and stores a firmware that operates the exposure apparatus 1.

The controller 170 controls pattern generations by the micro-mirror array 100 in this embodiment. The controller 170 obtains the pattern to be imaged via an interface (not shown), and generates pattern data (pixel coordinate information) for each exposure shot. The controller 170 selects to reflect or not reflect from the mirror array 102 of the micro mirror array 100 in accordance with the pattern data for each exposure shot. The controller 170 controls generations of the position correction data and alignments for the wafer 40, as described later.

A description will be given of operations of the exposure apparatus 1. After the wafer 40 fed by a transportation system (not shown) is held on the wafer stage 50 via the wafer chuck 52, a coordinate of the wafer 40 on the apparatus is measured by detecting the wafer alignment mark (“WA mark”) formed on the wafer 40 by using the off-axis scope 60. The wafer 40 is moved below the projection optical system 30 based on this measuring result, and sequentially exposed every 200 μm square. In exposure, the light emitted from the light source section 12, for example, Koehler-illuminates the micro-mirror array 100 through the illumination optical system 14 and the beam splitter 20. The light that has been reflected by the micro-mirror array 100 and reflects the circuit pattern transmits the beam splitter 20 and forms an image on the wafer 40 through the projection optical system 30.

The semiconductor device chip is as large as about 10 mm, and a single exposure cannot expose the whole surface. Accordingly, the circuit pattern is divided, and the controller 170 controls the micro-mirror array 100 and sequentially forms the pattern, thereby transferring a pattern corresponding to each position. The wafer stage 50 may stop every exposure for sequential exposing, or the exposure may be synchronized with the pulsed emissions while the wafer stage 50 continuously moves at a speed much lower than the exposure time period.

Similar to the conventional exposure apparatus, the off-axis scope 60 measures the coordinate of the water 40 in this alignment. In the measurement by the off-axis scope 60, the exposure optical axis does not accord with the optical axis of the alignment scope 150. Therefore, for highly precise alignments, a precise baseline correction is necessary for a distance between the detection position of the alignment scope 150 and the patterned position. As described above, this embodiment arranges the alignment marks 104 on the micro-mirror array 100 and the reference mark 70 on the wafer stage 50 for the baseline correction.

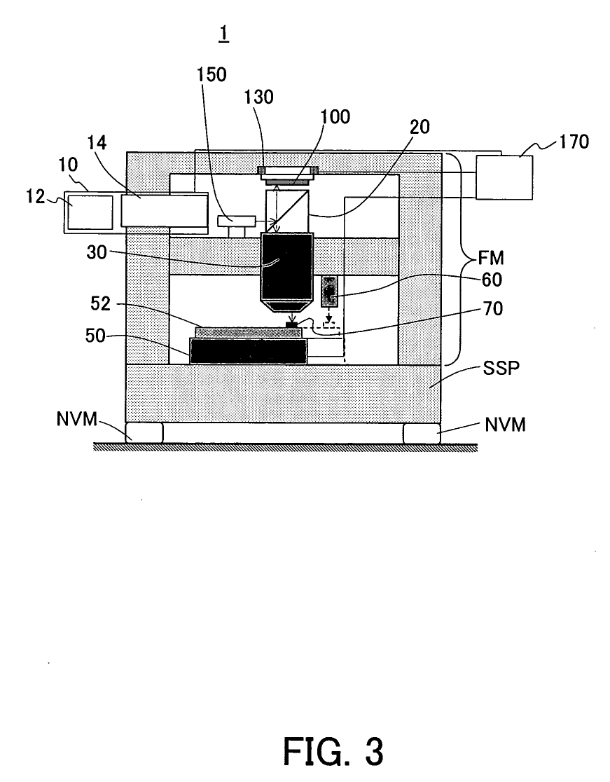

FIG. 3 is a schematic sectional view of the exposure apparatus 1 in the baseline correction. Referring to FIG. 3, in the baseline correction, the reference mark 70 near the wafer 40 on the wafer chuck 52 (at the edge of the wafer chuck 52) is first moved under the projection optical system 30 near a position at which the alignment marks 104 on the micro-mirror array 100 are projected. While the alignment scope 150 is configured to measure the surface position of the micro-mirror array 100, it is moved by a moving means (not shown) and detects images of the reference mark 70 and the alignment marks 104 in the baseline correction. Since the reference mark 70 and the alignment mark 104 are conjugate with the projection optical system 30, the alignment scope 150 can capture the reference mark 70 and the alignment mark 104 at the same time. Suppose, for example, that the reference mark 70 has a one-line shape, the alignment mark 104 has a two-line shape. When the line of the reference mark 70 is located in the middle of two lines of the alignment mark 104, both coordinates accord with each other. A positional relationship between the reference mark 70 and the alignment mark 104 is detectable at high precision when the image taken by the alignment scope 150 is processed. A coordinate of the wafer stage 50 is stored when the position of the reference mark 70 accords with the position of the alignment mark 104. In this embodiment, the alignment scope 150 detects the mark by using the light having the same wavelength as that of the illumination light LL. Use of the light having the same wavelength as that of the illumination light LL is preferable because the aberration of the projection optical system 30 affect the exposure time and baseline correction equally.

Then, the reference mark 70 is moved to a measuring position for the off-axis scope 60 (which is shown by a broken line in FIG. 3), and the coordinate of the wafer stage 50 is stored when the position of the reference mark 70 accords with the measurement reference position of the off-axis scope 60.

The baseline is defined as a difference (or an offset) between the coordinate of the wafer stage 50 when the position of the reference mark 70 accords with the position of the alignment mark 104 and the coordinate of the wafer stage 50 when the position of the reference mark 70 accords with the measurement reference position of the off-axis scope 60. The positions between the mirror array 102 and the alignment marks 104 are known because they are precisely measured when the micro-mirror array 100 is produced.

Thus, the exposure apparatus 1 of this embodiment can correct not only the baseline between the off-axis scope 60 and the exposure optical axis, but also the driving direction of the wafer stage 50 and the orientation of the mirror array 102. These corrections are also available by changing the coordinate of the wafer stage 50 or by driving the mirror driving mechanism 130.

While this embodiment arranges four alignment marks 104 on the micro-mirror array 100, as shown in FIG. 2, two alignment marks are enough to measure an offset of the mirror arrangement in the rotational direction. However, four alignment marks 104 improve the measuring precision.

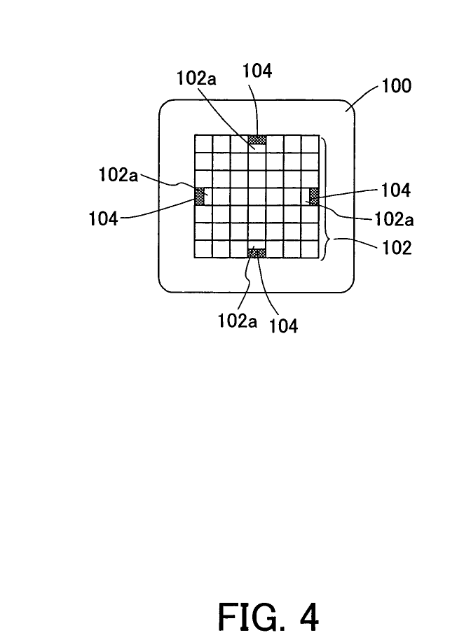

As shown in FIG. 4, the alignment marks 104 may be patterned on the mirror array 102 in the micro-mirror array 100. In this case, the mirrors 102a in which the alignment marks 104 are patterned are not used for exposure. Here, FIG. 4 is a plane view of the micro-mirror array 100 viewed from a reflection surface side of the fine mirror.

Alternatively, the baseline is corrected by forming the alignment mark using the micro-mirror array 100 itself and detecting the alignment mark. Since the alignment mark 104 can be formed on the same plane as the mirror array 102 when the micro-mirror array 100 itself forms the alignment mark, the precision improves in comparison with a formation of the alignment mark 104 on the mirror 102a and a formation of the alignment mark 104 at a position outside the mirror array 102.

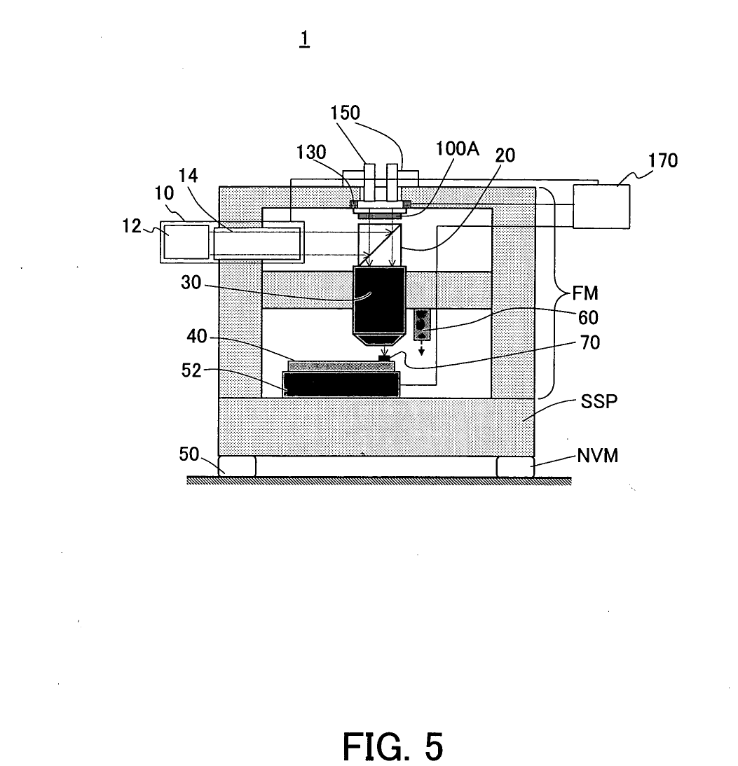

The exposure apparatus 1 may arrange, as shown in FIG. 5, the alignment scope 150 at a side opposing to the reflection surface of the micro-mirror array 100A, and detect the alignment mark 104 from the side opposing to the reflection surface of the micro-mirror array 100A. Here, FIG. 5 is a schematic sectional view of a structure of the inventive exposure apparatus 1.

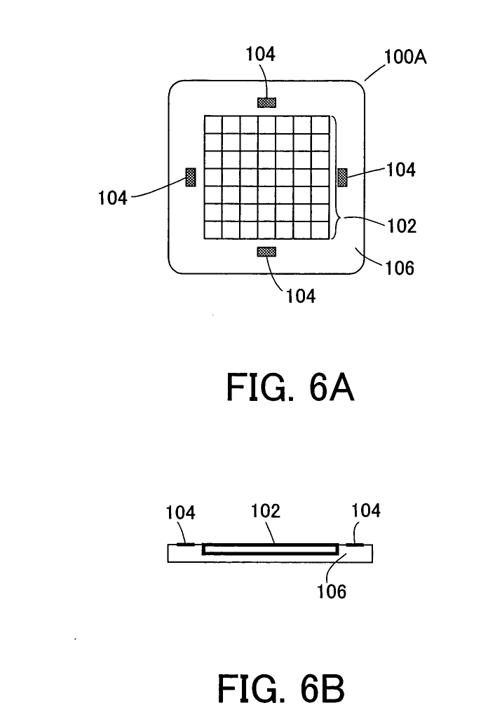

FIG. 6 shows a micro-mirror array 100A when the alignment mark 104 is detected from the side opposing to the reflection surface of the micro-mirror array. Referring to FIG. 6, the mirror array 102 is arranged on a transparent substrate 106. The mirror array 102 is produced by the Si fine processing etc. as described above.

The reflection surface of the mirror array 102 is formed on the same plane as the surface of the transparent substrate 106, as shown in FIG. 6B. Four alignment marks 104 are formed around the mirror array 102 as shown in FIG. 6A. The alignment mark 104 is formed on the transparent substrate 106, and detectable from the side opposing to the reflection surface of the micro-mirror array 100A. The illumination part for illuminating the alignment mark 104 for the baseline correction is advantageously unnecessary as the alignment mark 104 is detected from the side opposing to the reflection surface of the micro-mirror array 100A.

A description will now be given of the high overlay accuracy realized by the exposure apparatus 1. In the alignment between the wafer 40 and the pattern in the exposure apparatus 1, the off-axis scope 60 measures the WA mark on the scribe line and the transferred or imaged area of the circuit pattern on the wafer 40, and the exposure position reflects the measuring result.

Prior to the exposure, plural WA marks are measured so as to obtain an arrangement of the chip (which is the image area of one semiconductor device or plural circuit patterns, and corresponds to the exposure shot in the stepper) and the magnification data. The sequential exposure follows based on the obtained data. This method is called a global alignment method, and advantageously shortens the alignment time period, since the exposure follows an arrangement of chips on the entire wafer and all the WA marks do not have to be measured for each chip.

However, the global alignment method cannot remove the distortion component in the chip. Accordingly, the exposure apparatus 1 of this embodiment also serves to image the pattern in accordance with the distortion in the chip.

More specifically, the controller 170 serves to hold or store the position correction data, and images the pattern in accordance with the distortion of the wafer by correcting the image data based on the position correction data of the exposure shot. Thereby, the distortion in the chip is reflected. The in-chip distortion occurs in the exposure apparatus due to the distortion aberration of the projection optical system and the wafer distortion in the post-exposure process.

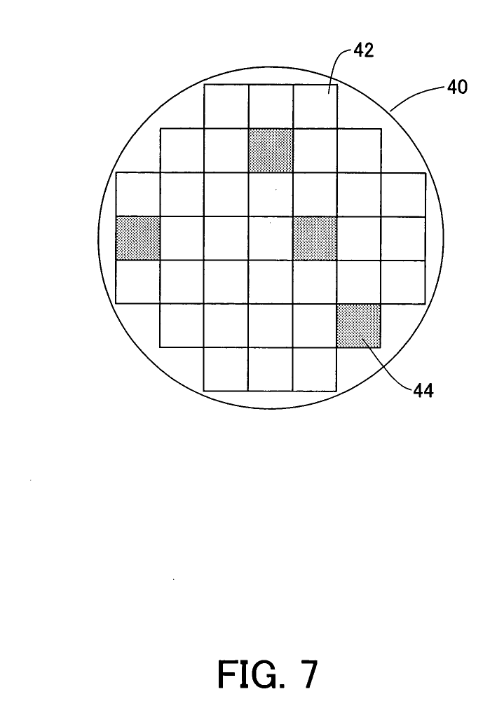

A description will be given of a generation of the position correction data. FIG. 7 shows the wafer 40 onto which the distortion measuring mark shots 44 that arrange distortion measuring marks at part of the normal layout are exposed. After the wafer 40 shown in FIG. 7 is processed, the distortion in the chip 42 is measured by using the long size measuring apparatus etc. The controller 170 stores the measuring result as the position correction data for use with the position correction. Since the distortion measuring mark does not have to be provided in each chip 42, the device design is never restricted.

The distortion measuring mark shots 44 disperse from the center of the wafer 40 in the radial direction, because the wafer's distortion due to the process tends to depend upon the radial direction. This embodiment assumes that shots at the same distance in the radial direction have the same distortion, and uses the same position correction data for corrections.

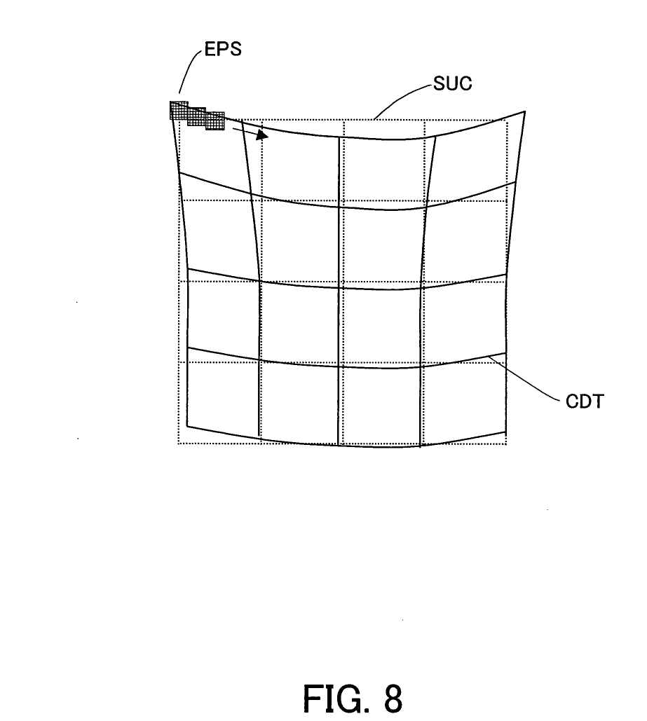

FIG. 8 shows a pattern transfer while the wafer's distortion is corrected. SUC is a designed coordinate system (design coordinate), and the exposure shots EPS are sequentially exposed along the designed lattice coordinate when there is no distortion. CDT is a coordinate system (corrective coordinate) of position correction data, and calculated from an interpolation from the measuring result of the undercoat wafer distortion. With distortion, the exposure shot EPS in sequentially exposed along this corrective coordinate CDT.

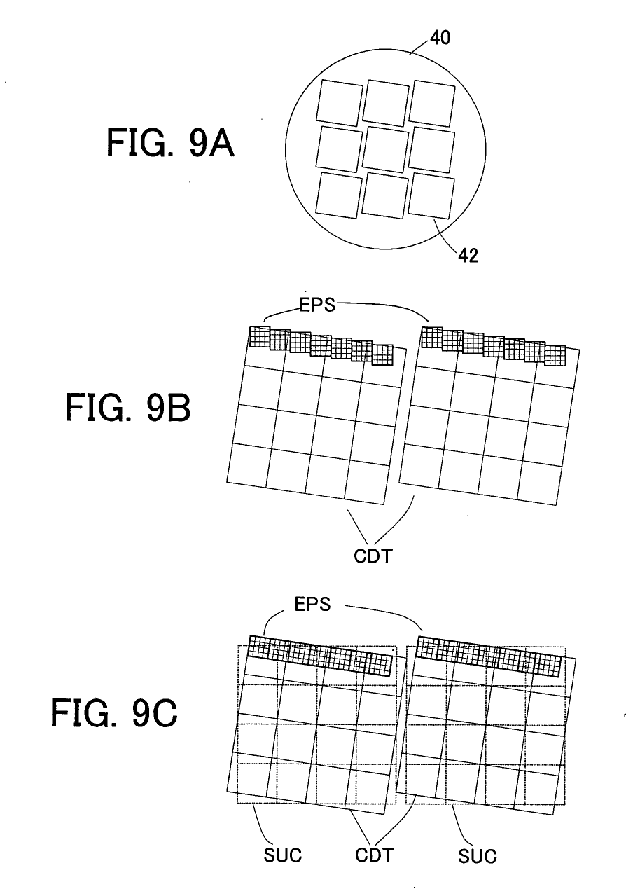

A description will now be given of a difference from the distortion correction in the conventional electron beam exposure apparatus. FIGS. 9A to 9C show one example of patterning of upper layer by using the inventive exposure apparatus 1, on a wafer 40 that has experienced the undercoat exposure by the conventional exposure apparatus. FIG. 9A shows the undercoat wafer 40. In the conventional exposure apparatus, the chip rotation occurs when the reticle's rotating direction does not accord with the stepping direction of the wafer. In other words, as shown in FIG. 9A, the coordinate system in the chip 42 and the coordinate of the arrangement of the chip 42 incline.

FIG. 9B shows an exposure in which only the positional distortion is corrected. FIG. 9B shows two shots as part of the wafer 40. Referring to FIG. 9B, a step occurs at a junction between exposure shots EPS, consequently lowering the connection precision for connecting exposed patterns. In the conventional electron beam exposure apparatus, the connection precision does not decrease due to the circular shape or a very small size of the imaging beam.

FIG. 9C shows an exposure in which the exposure shots EPS are inclined based on the position correction data. FIG. 9C shows two shorts as part of the wafer 40, similar to FIG. 9B. Referring to FIG. 9C, the corrective coordinate CDT for the designed coordinate SUC is calculated in accordance with the chip rotation, and the exposure shots ESP are sequentially exposed along the corrective coordinate CDT. In other words, an inclination of the exposure shots ESP in accordance with the inclination (or distortion) of the undercoat wafer 40 provides patterning without lowering the connection precision. The exposure apparatus 1 exposes the wafer by rotating the micro-mirror array 100 via the mirror driving mechanism 130 based on the chip rotation obtained from the measurement of the distortion.

While this embodiment separately discusses the chip rotation and distortion, the actual exposure has the chip rotation and distortion at the same time. The exposure apparatus 1 exposes the wafer while correcting the position and rotation of each exposure shot based on the position correction data.

Thus, after the positional magnification is calculated for each shot using the normal global alignment, the exposure of each chip is based on the position correction data corresponding to the shot position. This configuration provides high overlay accuracy corresponding to the in-shot distortion.

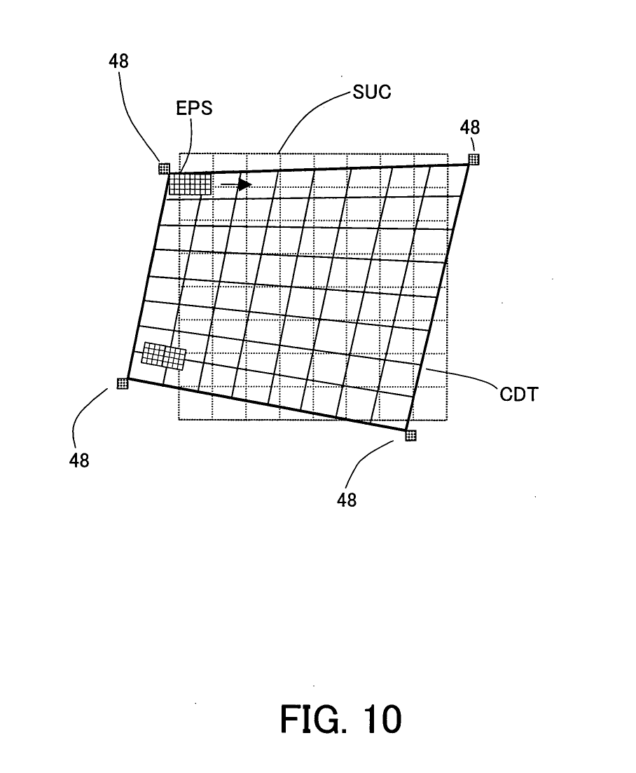

A description will now be given of a method for obtaining the position correction data without using the long size measuring apparatus. FIG. 10 is a plane view showing a specific ship on the wafer 40. Referring to FIG. 10, the WA marks 48 are arranged on four corners of each chip on the scribe line, and detectable by the off-axis scope 60. Similar to FIG. 8, SUC is a design coordinate, and CDT is a corrective coordinate. A coordinate system is converted by linearly interpolating the positions of these four WA marks 48, and the position correction data (or corrective coordinate CDT) is formed. The two dimensional curve approximation is available by arranging the WA marks among the four WA marks 48. The multi-dimensional approximation is available by further arranging the WA marks.

Since the position correction data is generated by arranging the WA marks on the scribe line, the distortion measuring mark shot does not have to be exposed as shown in FIG. 7. In other words, the circuit pattern needs no distortion measuring marks, providing the high overlay accuracy without restricting the design of the circuit pattern.

Since the exposure apparatus 1 exposes the fine circuit pattern generated by the micro-mirror array without restraining the device design with high overlay accuracy, and thus provides devices, in particular, system LSIs with high throughput and economical efficiency.

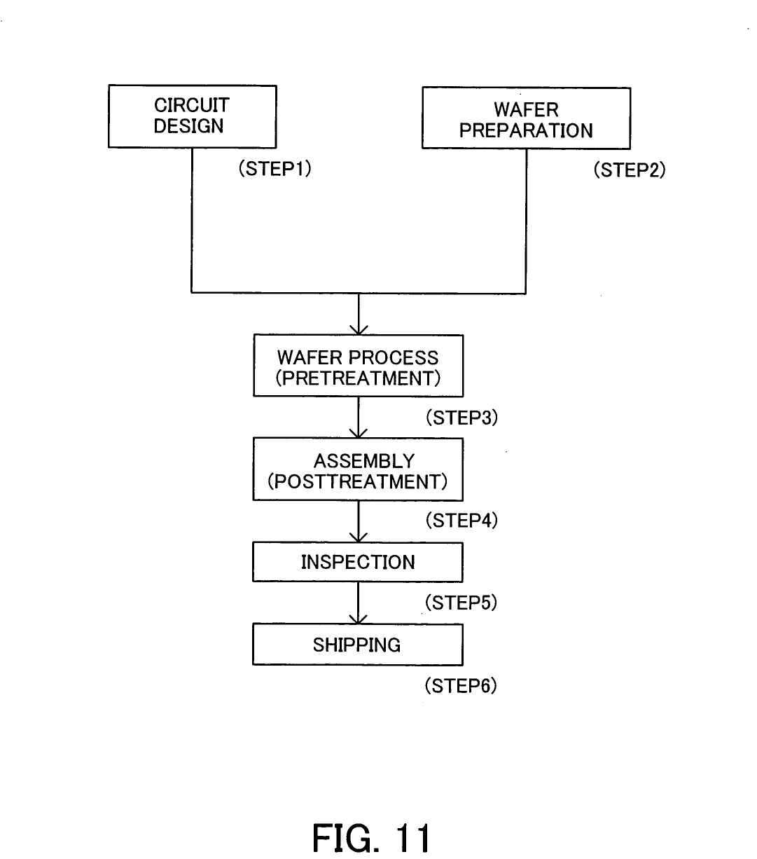

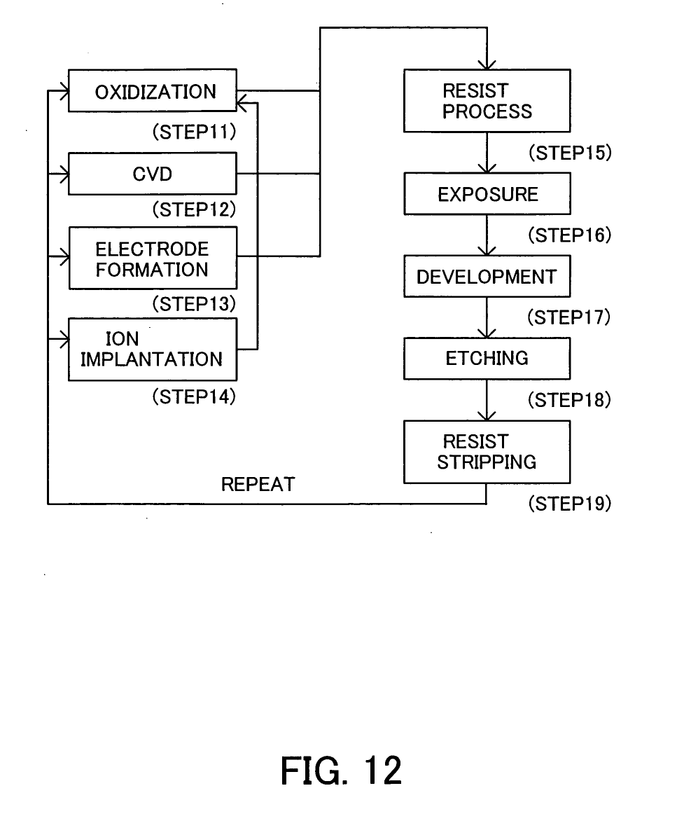

Referring now to FIGS. 11 and 12, a description will now be given of an embodiment of a device manufacturing method using the above exposure apparatus 1. FIG. 11 is a flowchart for explaining a fabrication of devices (i.e., semiconductor chips such as IC and LSI, LCDs, CCDs, etc.). Here, a description will be given of a fabrication of a semiconductor chip as an example. Step 1 (circuit design) designs a semiconductor device circuit. Step 2 (wafer preparation) manufactures a wafer using materials such as silicon. Step 3 (wafer process), which is referred to as a pretreatment, forms actual circuitry on the wafer through photolithography using the mask and wafer. Step 4 (assembly), which is also referred to as a post-treatment, forms into a semiconductor chip the wafer formed in Step 3 and includes an assembly step (e.g., dicing, bonding), a packaging step (chip sealing), and the like. Step 5 (inspection) performs various tests for the semiconductor device made in Step 4, such as a validity test and a durability test. Through these steps, a semiconductor device is finished and shipped (Step 6).

FIG. 12 is a detailed flowchart of the wafer process in Step 3. Step 11 (oxidation) oxidizes the wafer's surface. Step 12 (CVD) forms an insulating film on the wafer's surface. Step 13 (electrode formation) forms electrodes on the wafer by vapor disposition and the like. Step 14 (ion implantation) implants ions into the wafer. Step 15 (resist process) applies a photosensitive material onto the wafer. Step 16 (exposure) uses the exposure apparatus 1 to expose a reticle pattern onto the wafer. Step 17 (development) develops the exposed wafer. Step 18 (etching) etches parts other than a developed resist image. Step 19 (resist stripping) removes disused resist after etching. These steps are repeated, and multilayer circuit patterns are formed on the wafer. This embodiment can provide higher-quality semiconductor devices than the prior art. Thus, the device manufacturing method that uses the exposure apparatus 1, and its resultant (intermediate and final) products also constitute one aspect of the present invention.

Furthermore, the present invention is not limited to these preferred embodiments and various variations and modifications may be made without departing from the scope of the present invention. For example, while the present invention describes an application of the pattern generating means to an exposure apparatus, the pattern generating means is applicable to another spatial modulation element, such as liquid crystal. In addition, a pattern generating means that has an alignment mark on approximately the same surface as the patterned surface serves as a pattern generator and constitutes one aspect of the present invention.

The present invention can provide an exposure apparatus and method, which does not restrict the device design, and provides high overlay accuracy.

This application claims a foreign priority benefit based on Japanese Patent Applications No. 2004-127620, filed on Apr. 23, 2004, which is hereby incorporated by reference herein in its entirety as if fully set forth herein.

1. An exposure apparatus comprising:
a projection optical system for projecting a predetermined pattern onto an object to be exposed; and
a pattern generating unit that includes plural pixels, and generates the predetermined pattern by driving the plural pixels, wherein said pattern generating unit has an alignment mark used for an alignment between the predetermined pattern and the object, on approximately the same surface as a surface on which the predetermined pattern is formed.

2. An exposure apparatus according to claim 1, wherein said pattern generating unit includes a micro-mirror array that arranges an array of mirrors.

3. An exposure apparatus according to claim 2, wherein the alignment mark is arranged on a reflection surface of the mirror.

4. An exposure apparatus according to claim 2, wherein said pattern generating unit includes a transparent substrate that has the micro-mirror array and the alignment mark arranged around the micro-mirror array.

5. An exposure apparatus according to claim 1, further comprising a detector for detecting the alignment mark.

6. An exposure apparatus comprising:
a projection optical system for projecting a predetermined pattern onto an object to be exposed; and
a pattern generating unit that includes plural pixels, and generates the predetermined pattern by driving the plural pixels,
wherein a first alignment mark used for an alignment between the predetermined pattern and the object is arranged on a side of the pattern generating unit on approximately the same surface as a surface on which the predetermined pattern is formed, and
wherein a second alignment mark used for an alignment between the predetermined pattern and the object is arranged on a side of the object on approximately the same surface as a focal plane of said projection optical system.

7. An exposure method for exposing an object so that a first pattern that is generated by driving plural pixels matches a second pattern that is formed on the object, said exposure method comprising the steps of:
storing as correction data an offset amount of the second pattern from an ideal position; and
forming the first pattern based on the correction data.

8. An exposure method according to claim 7, wherein the correction data is produced based on a position measuring result of a mark included in the second pattern.

9. An exposure method according to claim 8, wherein the mark is arranged on a scribe line of the second pattern.

10. An exposure method according to claim 9, wherein the correction data is produced by an interpolation of coordinate data based on the position measuring result of the mark.

11. An exposure method according to claim 7, wherein the correction data includes positional effect information and rotational offset information of the second pattern.

12. An exposure apparatus that has an exposure mode for executing an exposure method according to claim 7.

13. A device manufacturing method comprising the steps of:
exposing an object using the exposure apparatus according to claim 1; and
developing the object that has been exposed.

14. A device manufacturing method comprising the steps of:
exposing an object using the exposure apparatus according to claim 6; and
developing the object that has been exposed.

15. A pattern generator comprising plural pixels, said pattern generator generating the predetermined pattern by driving the plural pixels, wherein said pattern generator has a reference mark for the predetermined pattern, on approximately the same surface as a surface on which the predetermined pattern is formed.

16. An alignment method between a predetermined pattern and an object used for an exposure apparatus that includes a projection optical system for projecting a predetermined pattern onto an object to be exposed, and a pattern generating unit that includes plural pixels, and generates the predetermined pattern by driving the plural pixels, said alignment method comprising:
a first obtaining step for obtaining a position of a stage that supports the object, when a reference mark arranged on the stage on approximately the same surface as an exposed surface of the object matches an alignment mark arranged on approximately the same surface as a surface on which a pattern is generated by the pattern generating unit;
a second obtaining step of obtaining a position of the stage, when a position of the reference mark matches a position of a measurement reference position for a measuring unit that measures a position of the object;
a calculating step for calculating an offset based on results of said first and second obtaining steps; and
an alignment step for providing an alignment between the predetermined pattern and the object based on the offset and a measuring result by the measuring unit.
